(19) United States
(12) Patent Application Publication
(10) Pub. No.: US 2011/0290774 A1
(43) Pub. Date: Dec. 1, 2011

(54) HANDLING AN INSERT TO IMPLANT IT IN A CELLULAR PANEL AND TO WITHDRAW IT FROM THE PANEL

(75) Inventor: Marc Denante, Marseille (FR)

(73) Assignee: EUROCOPTER, Marignane (FR)

(21) Appl. No.: 13/111,153

(22) Filed: May 19, 2011

(30) Foreign Application Priority Data
May 31, 2010 (FR) 10 02276

(51) Int. Cl. H05B 1/02

(52) U.S. Cl. 219/201; 219/494

(57) ABSTRACT

Tooling is organized firstly to implant an insert (1) in a cellular panel (2) by means of a thermally reactive sealing material (3), and secondly to withdraw the insert from said cellular panel (2). The tooling comprises an instrument (9) provided a heater endpiece (10) that is in relationship with heater means (11) and that is arranged as a finger suitable for being received inside a cavity (6) in the insert (1) in order to raise the temperature of the sealing material (3). The instrument (9) is fitted with grip means (12) for gripping the insert (1), which grip means are arranged on the heater endpiece (10), and with relative positioning means (13) for positioning the instrument (9) relative to the cellular panel (2).

### CROSS REFERENCE TO RELATED APPLICATIONS

The present application claims priority benefit from patent application FR 10/02276 of May 31, 2010, the content of which is incorporated herein by reference.

### BACKGROUND OF THE INVENTION

(1) Field of the Invention

The invention relates to fastener devices that make use of an insert that is implantable in a structural element for subsequently receiving a fastener member co-operating therewith. More particularly, the present invention relates to ways of implanting such an insert in a cellular panel that includes a honeycomb-structure cellular core, and for withdrawing said insert from such a panel. The invention provides a method and tooling for handling the insert in order to implant it in the cellular panel and in order to withdraw it from the panel, if necessary.

(2) Description of Related Art

Cellular panels comprise a honeycomb-structure cellular core or the like that is integrated with one or two plates by sealing in order to hold the panel in shape. Cellular panels may be made at least in part out of composite materials in order to make them lighter, and in particular thermoplastic material. Such cellular panels present the advantage of being robust and lightweight, and they are particularly useful in the field of aviation for fitting to aircraft, which it is desirable to make as light as possible.

For the purpose of fastening external elements on a cellular panel, it is common practice to make use of inserts that are implanted in the thickness of the panel and that include respective cavities enabling them to co-operate with complementary fastener members. An insert is introduced inside a housing of appropriate dimensions that is previously formed in the thickness of the panel, and it is secured to the panel by sealing. A sealing material is interposed between the panel and the insert, occupying the cells of the panel core that border the housing.

The general problem posed lies in the ways in which the insert and the cellular panel are secured to each other and separated from each other.

Cellular panels are made of composite materials incorporating a sealing material that has a binder that is sensitive to temperature change. Such a binder may be of the thermosetting type which is caused to harden by being polymerized under the effect of a temperature rise, or of the hot-melt type, where hardening takes place under the effect of a material in a liquid or pasty state solidifying to a solid state on cooling. The physicochemical characteristics and the mechanical strength of the binder are modified under the effect of a rise in temperature, in particular up to a vitreous transition phase that it is necessary to avoid reaching, since that would run the risk of severely degrading the characteristics of the binder. In order to implant or withdraw the insert, it is necessary for the implementation used to avoid harming the cellular panel structurally and to avoid harming its physicochemical properties. In particular, the zone in which the insert is implanted is subjected to mechanical and thermal stresses, but it must nevertheless preserve its own integrity, and the change in temperature to which the binder is subjected must take account of the reaction of the cellular panel to such a temperature change.

With reference more particularly to implanting an insert, the insert may be implanted during fabrication of the cellular panel, by baking of the cellular panel in combination with the insert fitted therein, which insert is embedded in the sealing material. The vitreous transition temperatures of the cellular panel and of the sealing material are the same, which is limiting as to the sealing capacities made available by the binder of the sealing material since it cannot be raised to a temperature higher than the vitreous transition temperature of the cellular panel. Furthermore, the technique of baking the cellular panel and the sealing material in combination remains reserved to implanting inserts during fabrication of the panel itself. Nevertheless, it is sometimes necessary to implant an insert, either during maintenance of the cellular panel or when replacing an insert that must also be withdrawn. It is desirable that such operations can be performed on the site where the cellular panel is installed, so as to avoid any need to dismantle the panel and subsequently put it back into place, which is undesirable given the maintenance costs involved.

Under such conditions, implanting an insert after the cellular panel has been fabricated tends to harm the panel because of the temperature rise induced in the zone in which the insert is implanted. In order to avoid degrading the cellular panel in this zone, the temperature to which the sealing material is raised and the way in which this temperature rise is performed are subject to the constraint of avoiding any temperature rise in that zone that is unsuitable for the cellular panel.

The time required for implanting the insert depends on the time required for hardening of the sealing material, which is slow and inconvenient. With an insert that is implanted during fabrication of the cellular panel, the time the panel needs to wait before the sealing material hardens gives rise to extra fabrication costs. When a maintenance operation is performed on the panel or an insert is implanted after the cellular panel itself has been fabricated, proper implantation of the insert is made difficult while waiting for the sealing material to harden, in particular because the sealing material is interposed between the insert and the wall of the housing that is to receive it. Complementary shapes between the housing and the insert are thus made necessary, with the drawback of constraining the available possibilities in terms of how the insert can be arranged in order to enhance incorporation thereof in the panel.

In terms more particularly of withdrawing the insert, such an operation is commonly performed by mechanically destroying the insert by machining it. Such a method implies using specific means that are complex, and a particular working environment. The machining operation gives rise to undesirable swarf, raises the temperature in the zone of the panel where the insert is implanted to an extent that it is difficult to control, and gives rise to vibration and cutting forces that can damage the panel structurally. Such a machining operation may be difficult to perform depending on the space available in the surroundings of the cellular panel. The insert may also be withdrawn by heating the insert and its near surroundings until the sealing material is thermally degraded. Such an operation raises the temperature of the panel in the zone where the insert is implanted in a manner that is uncontrolled, and there is a risk of the vitreous transition temperature specific to the cellular panel being exceeded, with the consequence of the mechanical strength and physicochemical properties of the panel being spoilt.

Mention is made of prior art documents.

Document FR 1 519 111 describes fastener members, attachments, and fittings, that are arranged to be inserted in a receiver element by applying high frequency vibration and a static force. A device serves to ensure that the fastener member is inserted in the receiver element. That device possesses a column extending from a base and on which there slides a head with a vertical hole having a tool carrier spindle engaged therein.

Document FR 2 106 075 describes heating an insert to the core in order to raise the temperature of a sealing material so as to preserve the cellular panel from an excessive temperature rise in the zone in which the insert is implanted. The space made available by the cavity in the insert that is for co-operating with the fastener member is used for introducing a heater endpiece. That solution enables the temperature of the sealing material surrounding the insert to be brought up to temperature through the material of the insert going towards its periphery, thereby limiting the impact of the temperature rise on the cellular panel in the zone in which the insert is implanted. Nevertheless, that technique remains uncontrolled as to obtaining the looked-for result of preserving the cellular panel.

Document GB 1 427 062 describes a tool for inserting and withdrawing metal inserts into and from a thermoplastic material by delivering heat via an electric heater element.

Document WO 03/046390 describes an assembly comprising an insert and tooling for handling the insert relative to a cellular panel. The tooling includes an instrument provided with a sonotrode that can be received inside a cavity in the insert in order to raise the temperature of the sealing material surrounding the insert. In order to insert the insert into the space, the sonotrode is fastened to a converter (not shown) that is formed by a piezoelectric vibration generator, for example. That converter is coupled in turn to a thrust unit driven by hydraulic or pneumatic drive, as is common practice in the field of ultrasound welding (cf. page 7, lines 13-17).

### SUMMARY OF THE INVENTION

The object of the present invention is to propose tooling and a method for handling an insert for implanting it in a cellular panel and for withdrawing it from the cellular panel.

The present invention seeks more particularly to propose such tooling having an arrangement that is adapted to enable both operations to be performed: respectively implanting and withdrawing the insert. The present invention also seeks to propose such tooling and such a method that are easy to implement for a cellular panel equally well while it is being fabricated or after it has been installed on site. Such tooling and such a method are also sought after that enable the insert to be implanted reliably in rigorous manner inside the cellular panel, by making best use of the sealing capacities made available by the binder of the sealing material. It is also desirable for such tooling and such a method to enable the insert to be bonded effectively and to enable it to be withdrawn, while nevertheless remaining certain that the structure and the mechanical and/or physicochemical characteristics specific to the cellular panel remain unaffected, in particular in the zone in which the insert is implanted.

The present invention is defined by the claims.

In an embodiment, the assembly comprises an insert and tooling for handling the insert relative to a cellular panel. Such a cellular panel is of the type including at least one cellular core arranged as a honeycomb or as an analogous cellular structure that provides a plurality of juxtaposed cells. The cellular core is fitted, in particular by sealing, against at least one outside plate of the cellular panel, and preferably between two such plates. In order to incorporate the insert inside the cellular panel, the panel includes a housing for receiving the insert, which housing is formed through the panel prior to using the tooling of the present invention. After being initially inserted inside the housing, the insert is secured to the cellular panel by means of a thermally reactive sealing material that is interposed between the insert and the wall of the housing. Since the structure of the panel is cellular, the wall of the housing is likely to include walls that delimit the heart of the cells from the panel, such that these cells are filled at least in part with the sealing material. The thermally reactive sealing material may equally well be a thermosetting material or a hot-melt material.

The tooling comprises an instrument that is provided with a heater endpiece in relationship with heater means. The heater endpiece is arranged as a finger that can be received inside a cavity that is included in the insert, thereby making it possible to raise the temperature of the sealing material surrounding the insert. Such a cavity is commonly provided to co-operate with a fastener member after the insert has been secured to the panel. Such a fastener member enables a desired fitting element to be attached to the cellular panel. The cavity in the insert is divided in particular with junction means for co-operating with complementary junction means forming part of the fastener member so as to enable them to be mechanically assembled together in reversible manner, e.g. by screw-fastening, by mutual engagement, and/or by clip-fastening, for example, or by any other analogous reversible assembly technique.

The tooling is mainly recognizable in that the instrument is fitted with grip means for gripping the insert and with relative positioning means for positioning the instrument relative to a bearing plane. Such a bearing plane corresponds to a major face of the cellular panel relative to which the insert is handled while the tooling is being used, the housing opening out into said major face of the panel for insertion of the insert that is received. The insert is suitable for being assembled to the instrument and for being placed in a determined position relative to the cellular panel by means of the tooling.

When the tooling is used for implanting the insert in the cellular panel, gripping the insert by the instrument enables the insert to be held and positioned accurately relative to the cellular panel. Centering and holding the insert in position inside the housing by means of the instrument until the sealing material has hardened ensures that the insert is positioned accurately and certainly inside the housing, in spite of the presence of the sealing material between them. Since a space is provided between the insert and the wall of the housing for receiving the sealing material and/or for enabling the insert to be passed into the inside of the housing, the centering of the insert inside the housing is maintained until the sealing material has hardened at least up to a threshold that is sufficient to secure the insert relative to the cellular panel. Centering and holding of the insert in position inside the housing by means of the instrument until the sealing material has hardened also serves to ensure that heat is diffused uniformly from the insert to the surrounding sealing material. The temperature rise and the change of state of the sealing material are thus uniform.

When the tooling is used for withdrawing the insert from the cellular panel, gripping the insert by means of the instrument makes such withdrawal possible by the insert being extracted by maneuvering the instrument, or analogously the endpiece, in corresponding manner. The insert is initially heated by means of the endpiece in order to weaken the hold exerted by the sealing material and to make it easy to break the sealing material when traction is exerted on the insert towards the outside of the cellular panel by means of the instrument carrying the endpiece.

The tooling is suitable for being used both for implanting the insert inside the cellular panel and for withdrawing the insert from the cellular panel. Holding the insert in position by means of the instrument serves both to center it inside the housing until the sealing material has hardened during implantation of the insert, and to enable the insert to be gripped by the instrument so that it can be withdrawn by being extracted after the heated sealing material has been weakened. This withdrawal is performed by extracting the insert along the axial direction in which it extends, without running any risk of structurally damaging the cellular panel. Since the endpiece is preferably provided with grip means, the hardening or conversely the weakening of the sealing material is the result of heat being diffused uniformly through the insert from the cavity therein that receives the endpiece closely, while avoiding any thermal damage to the cellular panel in which the edges of the housing it contains are subjected to the same temperature transmitted from the periphery of the insert.

Said grip means are advantageously formed on the endpiece, in particular being formed by junction means that co-operate with the complementary junction means included in the cavity in the insert enabling it to engage the said fastener member. The shape of the endpiece is defined by the shape of the cavity in the insert, which it fits closely. More particularly, the endpiece is of a shape that is complementary to the shape of the cavity, such that their walls can be placed in contact with each other and such that the endpiece and the insert can be put into co-operation so as to enable the insert to be gripped by the instrument. Such an endpiece is advantageously mounted on the instrument in removable manner and is suitable for being selected from a set of endpieces of respective shapes forming part of the tooling, or for being shaped specifically, depending on requirements, when faced with an insert having a cavity of a special shape.

Since the cavity is centered inside the insert, and since the shape of the endpiece is easily adapted to the shape of the cavity that it fits closely, heat is transmitted from the endpiece to the insert in uniform manner. Since the temperature of the insert at its periphery is uniform, the sealing material is heated uniformly by the insert. Controlling the temperature of the endpiece makes it possible to control the temperature of the sealing material throughout its volume, and the temperature to which the wall of the housing formed through the cellular panel is raised. Controlling the temperature of the endpiece is made useful for avoiding and/or causing the sealing material entering a vitreous transition phase when implanting and/or removing/withdrawing the insert, and also for preserving the cellular panel from being heated above a threshold temperature that might damage it.

More particularly, and in a preferred embodiment, the tooling includes regulator means for continuously regulating the heating power delivered by the heater means. These regulator means depend in particular on at least one temperature sensor carried by the instrument at the margin of the endpiece. The proximity between at least the sensor and the endpiece makes it possible to measure the temperature to which the insert is actually subjected, and thus the temperature that is transmitted to the sealing material surrounding the insert.

The tooling preferably includes regulator means for regulating the power consumed by the heater means. Such regulator means constitute safety means against excessively heating the insert, for preventing degrading the binder present in the cellular panel and/or in the sealing material. Such regulator means may be constituted, for example, by timing the supply of energy to the heater means, or preferably by putting the heater means into communication with an energy source, itself in communication with means for measuring the quantity of energy delivered, and associated with means for interrupting the delivery of energy coming from the energy source beyond a determined threshold.

In an advantageous embodiment, the energy source is constituted by at least one energy supply that can be recharged with a determined quantity of energy corresponding to a single endpiece-heating operation. Such an energy supply has storage capacity that is just enough for a single operation of heating the endpiece and corresponding to implanting or withdrawing a single insert, the supply being organized so as to be exhausted after each operation of heating the endpiece and so as to need recharging in order to perform a new operation of heating the endpiece.

In an embodiment of said positioning means, they comprise at least one support leg for holding a frame carrying the instrument on a bearing plane, the leg extending in a direction in which the endpiece extends axially. The leg preferably includes at its free end at least one member for holding the frame to said plane, advantageously of a type presenting adherence, e.g. being formed by a suction cup or an analogous member.

The tooling preferably includes movement means for moving the endpiece relative to said bearing plane in a direction in which the endpiece extends axially. Such movement means are advantageously used for extracting the insert from the housing, or indeed for approaching the endpiece to the insert inserted in the housing for the purpose of assembling them together or for approaching the endpiece while assembled with the insert for the purpose of inserting the insert into the housing.

In variant embodiments, taken in isolation or in combination, the movement means of the instrument may be interposed equally well between the frame and the instrument, between the instrument and the endpiece, and/or, and preferably, they are incorporated in said support leg, which is arranged telescopically, for example.

In an advantageous embodiment, the movement means are fitted with rating means enabling them to be used spontaneously from a determined threshold of the mechanical resistance exerted by the sealing material engaged on the insert against said spontaneous maneuvering by the movement means.

The present invention also provides a method of using an assembly comprising the tooling for handling the insert relative to a cellular panel, as described above. More particularly, the method consists in handling the insert relative to a cellular panel that includes a housing for receiving the insert and relative to which it is equally possible to implant the insert or to withdraw it.

In its general principles, such a method comprises in particular the operations consisting in heating the insert by means of the endpiece until a change of state is obtained in a sealing material interposed between the insert and the housing that receives it, which housing is formed through the cellular panel.

In the present invention, such a method is mainly recognizable in that it comprises the operation of putting the insert into engagement with the instrument, and more particularly the insert into engagement with the endpiece via said grip means. This engagement is preferably performed prior to heating the endpiece, and the insert is held in position inside the housing by means of the instrument to which it is assembled, from initializing the operation of heating the endpiece and until at least a change of state has been obtained in the sealing material.

When the sealing material is a thermosetting material, the change of state of the sealing material may correspond to the material passing:

from the naturally pasty or solid state to a thermally hardened solid state suitable for fastening the insert to the cellular panel; or

conversely from the thermally hardened solid state to a vitreous transition phase, weakening the mechanical strength characteristics of the sealing material to enable the insert to be withdrawn from the cellular panel.

Equally well, when the sealing material is a hot-melt material, the change of state of the sealing material may correspond to the material passing:

from the naturally pasty state to a solid state, or from the naturally solid state to a pasty state and then, after interrupting the heating of the endpiece, once more to a new solid state, in order to fasten the insert to the cellular panel; or

conversely from the naturally solid state to a pasty or semi-liquid or even liquid state for withdrawing the insert from the cellular panel.

More particularly, the operation of heating the endpiece consists in heating the endpiece while continuously regulating its heating temperature as a function of the temperature of the insert as measured continuously from information coming at least from said temperature sensor.

More particularly, when the tooling is used for implanting the insert in the cellular panel, the method of the present invention comprises the operations consisting in:

arranging a housing for receiving the insert inside the cellular panel;

interposing a sealing material between the insert and the wall of the housing;

introducing the heater endpiece inside a cavity included in the insert;

placing the insert inside the housing;

heating the heater endpiece to raise the temperature of the sealing material via the insert until a change of state in the sealing material is obtained; and

withdrawing the heater endpiece from the cavity of the insert, at least after the change of state of the sealing material has been obtained.

According to the present invention, such a method of implanting an insert in a cellular panel is mainly recognizable in that the operation of maintaining the insert by means of the instrument continues from the operation of initializing heating of the heater endpiece until an operation of obtaining hardening as obtained by hardening of the sealing material at a predetermined threshold for securing the insert to the cellular panel.

The method of the invention for implanting an insert in a cellular panel more particularly comprises the operations consisting in:

assembling the insert with the instrument via grip means;

introducing the insert inside the housing equally well before or after assembling the insert with the instrument;

positioning the instrument relative to the cellular panel via positioning means, such that the tooling bears against the large face of the cellular panel and the insert is centered inside the housing;

keeping the insert centered inside the housing by the positioning means during the operation of heating the heater endpiece and until the operation of obtaining hardening with the sealing material hardening at the predetermined threshold; and

separating the insert from the instrument by undoing the co-operation between the grip means and the insert, and then withdrawing the heater endpiece from the cavity included in the insert.

The insert and the instrument may be assembled together after the insert has been put into the housing included in the cellular panel, by approaching the insert and in particular its endpiece by using the movement means. Such assembly may also occur before the insert has been introduced into the housing included in the cellular panel, the insert assembled to the endpiece being introduced inside said housing and being positioned relative to the cellular panel by the positioning means of the tooling.

Advantageously, the operation of heating the endpiece consists in heating the endpiece while continuously regulating its heating temperature so that the temperature of the insert does not exceed a temperature corresponding to a vitreous transition phase of the identified binder incorporated in the cellular panel or to a vitreous transition phase of the identified binder incorporated in the sealing material. These two binders may present the same thermal reaction characteristics in order to improve the securing of the insert to the cellular panel.

Still more particularly, the tooling is suitable for being used to withdraw an insert from the cellular panel to which it has been secured by means of a sealing material. Such a method proposed by the present invention comprises, in general terms, the operations consisting in:

initially gripping the insert by means of the instrument;

heating the insert by means of the heater endpiece to a predetermined temperature threshold until a change of state is contained in the sealing material, in particular between a solid state and equally well an identified pasty and/or liquid state, or a vitreous transition phase; and

withdrawing the insert from the housing included in the cellular panel by extracting it therefrom by using the movement means.

Depending on the nature of the sealing material, its weakening caused under the effect of the temperature rise may give rise:

either to its softening when the sealing material is a hot-melt material; or

else to it being put into its vitreous transition phase, thereby weakening its mechanical strength, when the sealing material is a thermosetting material.

Preferably, when the sealing material is a thermosetting material:

the operation of heating the heater endpiece consisting in heating the heater endpiece while continuously regulating its heating temperature until the sealing material is caused to pass from its thermally-hardened solid state to a vitreous transition phase that weakens its mechanical strength characteristics; and

the operation of extracting the insert consisting in shearing the sealing material in the vitreous transition phase by the movement means applying traction on the insert engaged on the grip means. As a result of opposing forces exerted by the instrument on the insert via the endpiece, and by the instrument against the corresponding face of the cellular panel via the positioning means and the movement means, shear is applied to the sealing material at the margin of the opening of the housing receiving the insert.

In a preferred embodiment in which the movement means are fitted with said rating means, spontaneous use thereof is caused via the rating means starting from a said determined threshold of weakening the sealing material as a result of its temperature rise and its change of state, either to a pasty state for a hot-melt sealing material or to a vitreous transition phase for a thermosetting material.

In other variants, the sealing material may be placed inside the housing independently of the insert, and more particularly prior to introducing the insert inside the housing, or indeed it may be incorporated in the insert at its periphery around its wall that is to be put into contact with the wall of the housing.

### BRIEF DESCRIPTION OF THE DRAWINGS

An embodiment of the present invention is described below with reference to the figures of the accompanying sheets, in which:

FIG. 1 is an illustration of tooling of the present invention with an insert for handling by means of said tooling relative to a cellular panel;

FIG. 2 is an illustration of the tooling shown in FIG. 1 in a situation for implanting the insert within the cellular panel; and

FIG. 3 is an illustration of the tooling shown in FIG. 1, in its situation for removing the insert from the cellular panel.

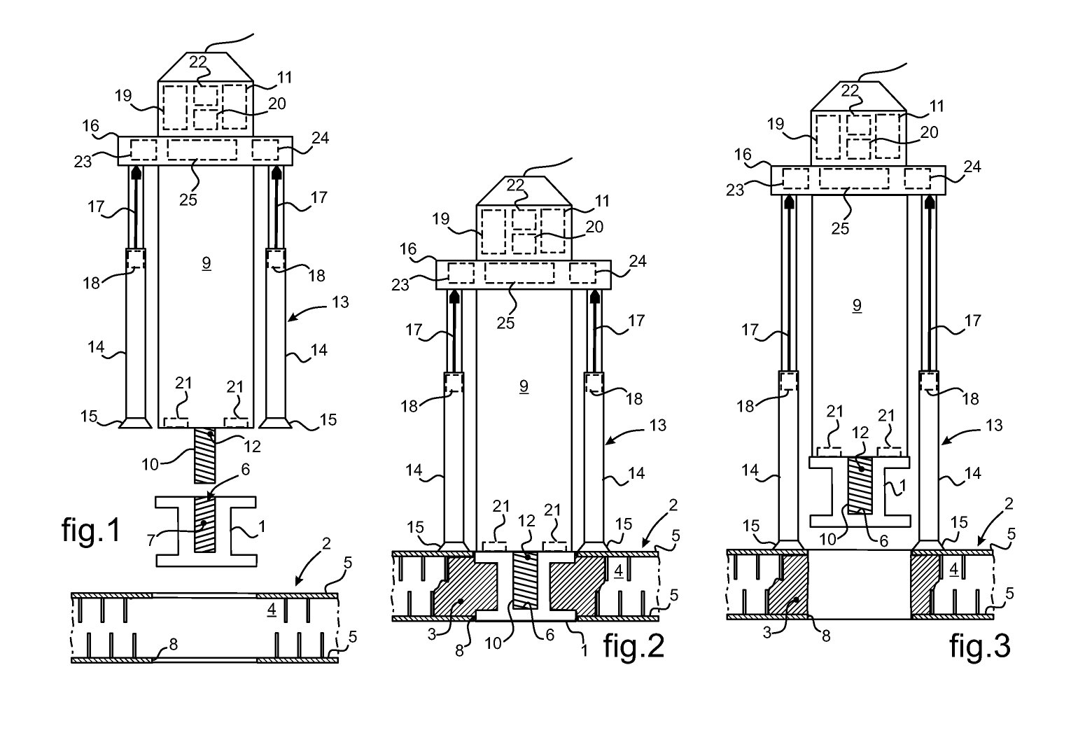

### DETAILED DESCRIPTION OF THE PREFERRED EMBODIMENT

In the figures, tooling is organized to handle an insert 1 relative to a cellular panel 2. The insert 1 is for implanting within the cellular panel 2 to which it is secured by means of a sealing material 3. The cellular panel 2 has a cellular core 4 that is housed between two solid outer walls 5 of the panel. The cellular core 4 is secured to the solid walls 5 by sealing, in particular by using a sealing material that incorporates a thermally reactive binder. The insert 1 includes a cavity 6 that is provided with junction means 7 for connecting it with a fastener member such as a thread or any other analogous means suitable for providing a releasable junction between the insert 1 and the fastener member. The fastener member is used in particular for attaching a structural fitting element on the cellular panel 2. A housing 8 is formed through the cellular panel 2 to receive the insert 1, and the sealing material 3 is interposed between the insert 1 and the wall of the housing 8 in order to secure the insert 1 to the cellular panel 2, as shown in FIG. 2.

The sealing material 3 is a thermally reactive material that is hardened under the effect of a change of temperature. Such a sealing material 3 may be a meltable material or a thermosetting material. Under the effect of a rise in temperature in the hot-melt sealing material 3, it softens, and conversely on cooling it hardens. Raising the temperature of a thermosetting sealing material 3 causes it to harden irreversibly. Beyond a predetermined threshold temperature rise, the thermosetting sealing material 3 is in a vitreous transition phase, with the consequence of its mechanical strength being significantly weakened. When implanting the insert 1 inside the cellular panel 2, the temperature rise needed for changing the state of the sealing material 3 must not give rise, after hardening, to a weakening of the mechanical strength of said sealing material 3 or of the binder incorporated in the cellular panel 2. In the event of the insert 1 being withdrawn from the cellular panel 2, the temperature rise needed for changing the state of the sealing material 3 must cause it to become weakened without also weakening the binder incorporated in the cellular panel 2. Furthermore, it must be possible to withdraw the insert 1 easily without any risk of damaging the mechanical structure of the cellular panel 2.

In order to raise the temperature of the sealing material 3 interposed between the insert 1 and the housing 8 that receives it inside the cellular panel 2, the tooling comprises an instrument 9 that is provided with a heater endpiece 10 associated with heater means 11. The heater endpiece 10 is of a shape complementary to the shape of the cavity 6 in the insert 1, such that inserting the heater endpiece 10 into the inside of the cavity 6 causes the surfaces of the wall of the cavity 6 to be put into contact with the peripheral surface of the heater endpiece 10. The shape of the heater endpiece 10 matches the shape of the cavity 6 so the transfer of heat through the insert 1 to the sealing material 3 with which it is surrounded takes place uniformly. Said putting of the surfaces of the cavity 6 and of the heater endpiece 10 into contact with each other is made easier by establishing co-operation between gripper means 12 included in the heater endpiece 10 and said junction means 7 forming part of the cavity 6. This co-operation serves to engage the insert 1 on the heater endpiece 10 for handling purposes.

By means of the heater endpiece 10 taking hold of the insert 1, it is possible to position and hold the insert 1 relative to the cellular panel 2 during handling, in particular for the purpose of implanting it in the cellular panel 2, as shown in FIG. 2, or for the purpose of removing it from the cellular panel 2, as shown in FIG. 3. The tooling includes positioning means 13 for changing the relative positioning between the instrument 9 and the cellular panel 2, which means may for example be arranged as support legs 14 for supporting the instrument 9 on the large face of the cellular panel 2 into which the housing 8 that receives the insert 1 opens out. These support legs 14 are provided at their bottom ends with attachment members 15, in particular members using suction, that are arranged as suction cups or the like, for example. Such attachment members 15 are members for holding the instrument 9 bearing stably against the large face of the cellular panel 2. The support legs 14 are fitted to a carrier frame 16 of the instrument 9 and they are arranged telescopically so as to allow the instrument 9 to move along the axis in which the heater endpiece 10 extends, perpendicularly to said large face of the cellular panel 2. The support legs 14 incorporate movement means 17 that are associated with rating means 18 for rating spontaneous extension movement of the support legs 14 against an opposing force induced by the sealing material 3 retaining the insert 1 inside the housing 8. The axial movement of the instrument 9 enables it to move the heater endpiece 10 assembled to the insert 1 perpendicularly towards or away from said large face of the cellular panel 2, respectively for inserting the insert 1 into the housing 8 or conversely for extracting it therefrom. In a manner that is analogous although structurally more complex, the movement means 17 and/or the rating means 18 could be arranged between the heater endpiece 10 and the instrument 9. In order to enable the insert 1 to be inserted inside the housing 8, the rating means 18 and the movement means 17 are inhibited. The rating means 18 and the movement means 17 that cause the support legs 14 to extend spontaneously are put into operation in order to extract the insert 1 from the cellular panel 2.

The insert 1 continues to be held and kept in position by the endpiece 10 throughout the operation of raising the temperature of the sealing material 3 until its hardening prevents the insert 1 from moving inside the cellular panel 2. With a thermosetting sealing material 3, the insert 1 is held in position by the heater endpiece 10 inside the housing 8 throughout the heating operation. For a hot-melt sealing material 3, the insert 1 is held in position by the heater endpiece 10 inside the housing 8 throughout the heating operation seeking to make the sealing material 3 pasty, and then while the sealing material 3 is cooling down, until it hardens. The dimensions of the housing 8 may be significantly greater than those of the insert 1, as shown in the figures. The function whereby the insert 1 is gripped by the heater endpiece 10 makes it possible to hold and position the insert 1 accurately relative to the cellular panel 2. In order to improve the bonding of the insert 1 inside the cellular panel 2, the insert may for example include two shoulders or analogous opposing axial retaining members inside the cellular panel. The presence of two such shoulders incorporated in the insert 1 makes it necessary to provide a housing 8 that allows at least one of those shoulders to pass into the inside of the housing 8, thereby having the consequence of the insert 1 being centered in random manner. Having the insert 1 gripped and positioned by means of the heater endpiece makes it possible to ensure that it is centered regardless of the dimensions of the housing 8 that receives it.

Having the insert 1 gripped by the heater endpiece 10 makes it possible to hold and extract the insert 1 during an operation of withdrawing it from the cellular panel 2, as shown in FIG. 3. With the heater endpiece 10 assembled to the insert 1, heating the heater endpiece 10 causes the sealing material 3 to change state, thereby weakening it in terms of mechanical strength. Once the mechanical strength of the sealing material 3 has been weakened, traction exerted on the insert 1 by the heater endpiece 10 under the effect of the axial thrust exerted by the movement means 17 on the instrument 9 causes the insert 1 to be withdrawn spontaneously by being extracted from the cellular panel 2. The spontaneous operation of the movement means 17 is limited by the rating means 18 that are adjusted to allow the instrument 9 to move as from a determined weakening threshold of the sealing material 3. This weakening threshold is determined as a function of a compromise between known weakening of the sealing material 3 as a function of its temperature rise, and the need to avoid damaging the cellular panel 2, both structurally and under the effect of degrading the binder that it incorporates as a result of excessively raising the temperature of the zone surrounding the housing 8. Extracting the insert 1 in this manner preserves the structure of the cellular panel 2 as a result of the weakened sealing material 3 shearing. The thrust exerted by the support legs 14 against the corresponding large face of the cellular panel 2 is applied around and close to the insert 1 assembled to the heater endpiece 10. This makes it possible via the movement means 17, with which the support legs are preferably fitted, to generate an opposing force suitable for causing the sealing material 3 to shear in the functional zone between the insert 1 and the housing 8, in particular at the opening of the housing 8 receiving the insert 1.

With a thermosetting sealing material 3, it is weakened by raising the temperature of the sealing material 3 to its vitreous transition phase. With a hot-melt sealing material 3, it is weakened by softening under the effect of being heated.

By way of example, the heater means 11 are housed in the head of the instrument 9, being in communication with a rechargeable independent energy supply 19 for powering them and being associated with various means for regulating their operation. The heater means 11 are preferably placed inside thermal lagging or thermal insulation filed to keep them at ambient temperature, such that the environment outside the instrument 9 and the operator are protected from the heating that is generated. The heater means 11 may equally well be powered with energy from the mains network and/or from said rechargeable energy supply 19.

Means 20 for regulating the heating power delivered by the heater means 11 are placed under the control of temperature sensors 21 located at the margin of the heater endpiece 10. During the operation of heating the heater endpiece 10, which is assembled to the insert 1, the proximity of the temperature sensor 21 in the vicinity of the heater endpiece 10 makes it possible to measure the temperature rise of the insert 1 continuously. On the basis of this measurement, the heating power applied to the heater endpiece 10 by the heater means 11 is adjusted continuously so as to avoid the heating power giving rise to an undesirable change of state in the binder incorporated in the cellular panel 2, and where appropriate while implanting the insert 1, of the binder incorporated in the sealing material 3.

Means 22 for regulating the power consumed by the heater means 11 serve to limit the energy available for each of the operations of heating the heater endpiece 10. Such a limitation of the energy made available prevents energy being delivered beyond a determined threshold corresponding to an operation of heating the heater endpiece 10 excessively, in order to be able to be certain that there has been no undesirable deterioration of the sealing material 3 and/or of the binder incorporated in the cellular panel 2. For example, the rechargeable energy supply 19 may be of energy-limited capacity, with it being necessary to recharge it between two operations of heating the heater endpiece 10.

The tooling advantageously includes a desk 23 for controlling its operation, which control desk is associated with control means proper 24 and with display means 25. The control desk 23 enables the operator to adjust and run the various active members of the tooling, such as the heater means 11 and the associated regulation means 20, 22, the supply of energy of the tooling, the movement means 17, and the rating means 18.

The tooling constitutes a self-contained device that is easily transportable by an operator and that is easy to use. Such tooling may be used both while fabricating the cellular panel 2, and while performing a maintenance operation on such a cellular panel 2. The insert 1 may be implanted during fabrication of the cellular panel 2 during a combined baking operation, and it may then be secured during a specific post-baking operation performed using the tooling. The handiness of the tooling makes it possible for it to be used with a cellular panel 2 that is isolated or that is incorporated in an assembly, or indeed that is installed on site inside an aircraft, in particular. The handiness of the tooling also enables it to be used in zones that are difficult to access, while enabling centered installation of the insert 1 inside the housing 8 to be certified, and while preserving the cellular panel 2 not only during an operation of installing the insert 1, but also during an operation of withdrawing it. The organization of the tooling and the methods provided for using it make it easily adaptable as a function of:

the environment outside the cellular panel 2;

the type of insert 1 by installing an interchangeable heater endpiece 10 that is adapted to the arrangement of the insert 1, in particular its cavity 6, and the junction means 12 that it includes; and

the hot-melt or thermosetting nature of the sealing material 3 used for securing the insert 1 to the cellular panel 2, and the composition of the materials from which the cellular panel 2 is formed.

What is claimed is:

1. An assembly comprising an insert with a cavity, heater means, and tooling for handling the insert relative to a cellular panel, the tooling including an instrument having a heater endpiece that is in relationship with the heater means and that is arranged as a finger receivable inside the cavity included in the insert in order to raise the temperature of a sealing material surrounding the insert, wherein the instrument is fitted with grip means for gripping the insert and with positioning means for positioning the instrument relative to a bearing plane; the handling tooling including regulator means for continuously regulating the heater power delivered by the heater means, which regulator means depend on at least one temperature sensor carried by the instrument at the margin of the heater endpiece; the tooling further including movement means for moving the heater endpiece relative to the bearing plane in a direction in which the heater endpiece extends axially.

2. An assembly according to claim 1, wherein said grip means are arranged on the heater endpiece of a shape that is defined by the shape of the cavity in the insert, which it matches closely.

3. An assembly according to claim 2, wherein said grip means are formed by junction means co-operating with complementary junction means included in the cavity of the insert.

4. An assembly according to claim 1, wherein the tooling includes regulator means for regulating the energy supply power consumed by the heater means, which regulator means constitute safety means against excessive heating of the insert.

5. An assembly according to claim 1, wherein said positioning means comprise at least one support leg for supporting on a bearing plane of a frame that carries the instrument, in a direction in which the heater endpiece extends axially.

6. An assembly according to claim 5, wherein the tooling includes movement means for moving the heater endpiece relative to the bearing plane arranged on said frame.

7. An assembly according to claim 6, wherein the movement means of the endpiece are interposed between the frame and the instrument, and/or are incorporated in the support legs, and/or are interposed between the instrument and the heater endpiece.

8. An assembly according to claim 7, wherein the movement means are fitted with rating means for rating their performance of a spontaneous maneuver from a determined threshold weakening of the mechanical resistance exerted by the sealing material engaged on the insert against said spontaneous maneuver of the movement means.

9. A method of implementing an assembly according to claim 1, for handling the insert by means of the tooling relative to a cellular panel that includes a housing for receiving the insert, equally well for implanting the insert in the housing, or for withdrawing it therefrom, wherein the method comprises an operation of mutually engaging the insert and the instrument prior to heating the heater endpiece, and the insert in a position-maintaining operation inside the housing by means of the instrument to which it is assembled, from an operation of initializing the operation of heating the heater endpiece until at least one change of state is obtained in the sealing material; this position-maintaining operation positioning the instrument relative to the cellular panel via positioning means; one of the positioning means being located between the instrument and the cellular panel; the method including an operation of heating the heater endpiece, which operation consists in heating the heater endpiece while continuously regulating the heating temperature as a function of an operation of measuring the temperature of the insert that is performed continuously on the basis of information coming from at least one temperature sensor.

10. A method according to claim 9, the handling tooling being used to implant the insert inside the cellular panel, the method comprising the operations consisting in:
arranging a housing for receiving the insert inside the cellular panel;
interposing a sealing material between the insert and the wall of the housing;
introducing the heater endpiece inside a cavity included in the insert;
placing the insert inside the housing;
heating the heater endpiece to raise the temperature of the sealing material via the insert until a change of state in the sealing material is obtained; and
withdrawing the heater endpiece from the cavity of the insert, at least after the change of state of the sealing material has been obtained;
wherein the operation of maintaining the insert by means of the instrument continues from the operation of initializing heating of the heater endpiece until an operation of obtaining hardening such as is obtained a hardening of the sealing material at a predetermined threshold for securing the insert to the cellular panel.

11. A method according to claim 10, comprising the operations consisting in:
assembling the insert with the instrument via grip means;
introducing the insert inside the housing equally well before or after assembling the insert with the instrument;
positioning the instrument relative to the cellular panel via positioning means;
keeping the insert centered inside the housing by the positioning means during the operation of heating the heater endpiece and until the operation of obtaining hardening with the sealing material hardening at the predetermined threshold; and
separating the insert from the instrument by undoing the co-operation between the grip means and the insert, and then withdrawing the heater endpiece from the cavity.

12. A method according to claim 11, an identified binder being incorporated in the cellular panel and an identified binder being incorporated in the sealing material, each of these identified binders having a vitreous transition phase, wherein the operation of heating the endpiece consists in heating the endpiece while continuously regulating its heating temperature so that the temperature of the insert does not exceed a temperature corresponding to a vitreous transition phase of the identified binder incorporated in the cellular panel or to a vitreous transition phase of the identified binder incorporated in the sealing material.

13. A method according to claim 9, the tooling being used to withdraw an insert from a cellular panel to which it is secured via a sealing material, said tooling including movement means for moving the heater endpiece relative to the bearing plane in a direction in which the heater endpiece extends axially, wherein the method comprises the operation consisting in:
initially gripping the insert by means of the instrument;
heating the insert by means of the heater endpiece to a predetermined temperature threshold until a change of state is contained in the sealing material; and
withdrawing the insert from the housing included in the cellular panel by extracting it therefrom by using the movement means.

14. A method according to claim 13, wherein the sealing material is a thermosetting material:
the operation of heating the heater endpiece consisting in heating the heater endpiece while continuously regulating its heating temperature until the sealing material is caused to pass from its thermally-hardened solid state to a vitreous transition phase that weakens its mechanical strength characteristics; and
the operation of extracting the insert consisting in shearing the sealing material in the vitreous transition phase by the movement means applying traction on the insert.

15. A method according to claim 14, wherein the movement means are caused to move spontaneously via rating means as from a said determined weakening threshold of the sealing material that results from its temperature rise and its change of state.
